(19) United States
(12) Patent Application Publication
(10) Pub. No.: US 2015/0114949 A1
(43) Pub. Date: Apr. 30, 2015

(54) Sheath Heater Capable of Reducing Electro-magnetic Wave

(71) Applicant: Sang Won LEE, Yorba Linda, CA (US)

(72) Inventor: Sang Won LEE, Yorba Linda, CA (US)

(21) Appl. No.: 14/068,343

(22) Filed: Oct. 31, 2013

(51) Int. Cl. H05B 3/48

(52) U.S. Cl. CPC H05B 3/48
USPC 219/534; 219/546

(57) ABSTRACT

The invention provides a sheath heater for reducing magnetic field drastically using destructive interference, in which a electrical-heating wire with terminals connected to both ends thereof is inserted in a metal tube so as to expose the terminals on both ends of the metal tube and insulating powder is filled so as to keep the inserted electrical-heating wire and the metal tube from touching each other, and two wires of the electrical-heating wire have one ends connected to each other so as not to touch each other, and the terminals connected to the ends are exposed to one of two ends of the metal tube. Since two electrical-heating wires having opposite directions are disposed in the metal tube and the generated the magnetic field act in opposite directions with respect to each other, they can be reduced drastically.

### FIELD OF TECHNOLOGY

The present invention relates to a sheath heater, and more specifically to a sheath heater, which can reduce electro-magnetic wave by disposing electrical-heating wires of opposite directions in a metal tube, interfering magnetic fields destructively, and reducing magnetic field drastically.

### BACKGROUND OF THE INVENTION

In general, a sheath heater means a heater with a structure that an electrical-heating wire is inserted in the middle of a metal tube and magnesium oxide (MgO) called as magnesia fills between the metal tube and the electrical-heating wire, insulating the electrical-heating wire and the metal tube from each other, and such sheath heaters have high resistance against vibration and shocks, such that they are widely used as heating heaters for industrial or home heating devices such as electrical furnace, dryer, bath tub, half-body bath tub, caster, oven, foot warmer, etc.

Such a conventional sheath heater is disclosed in detail in a Korean Patent 20-0387294 (Sheath Heater).

However, the conventional sheath heater of the above has problems as follows.

If the above sheath heater is applied with electric power, the current flows through an electrical-heating wire inside, and then magnetic field (electro-magnetic wave) is generated according to Ampere's law.

If a user, especially infant or child in growth stage or a pregnant woman, is radiated with such magnetic field (electro-magnetic wave) for a predetermined time period, then serious health problems such as physico-mental disorder, attention deficit hyperactivity disorder (ADHD), hyper behavioral disorder, etc. may be caused, such that people avoid using such devices.

In particular, recently regulations on electro-magnetic wave are being strengthened, and for example, a UN organization, the International Agency for Research on Cancer (IARC) determined the electro-magnetic wave to be a second class of carcinogen and found it to be a ‘carcinogenic material’. (Naver Knowledge Encyclopedia, News and Common Sense Dictionary, 2013, Parkmoongak)

Also, since the above conventional sheath heater has a single wire in the metal tube, in order to achieve a given thermal efficiency, the length of the wire and the tube must be lengthened, and if such sheath heater is applied to an electrical heater, the width and length of the electrical heater must be increased unnecessarily resulting a over-sized, and even though a plurality of wires may be installed to make the metal tube short, in such case, the electrical power consumption becomes serious.

### SUMMARY OF THE INVENTION

### Problems to Solve

The invention is contrived in order to solve the above problems, and is to a sheath heater for reducing electro-magnetic wave, which can cause a destructive interference of and reduce magnetic field (electro-magnetic wave) dramatically, and while maintaining a thermal efficiency as such as in the prior arts, the device can be made in a reduced size.

### Solutions to Problems

The invention for solving the above problems provides a sheath heater, which comprises a metal tube, an electrical-heating wire with terminals on both ends inserted in the metal tube and exposed on both ends of the metal tube, and insulating powder packed therein in order to keep the metal tube and the inserted electrical-heating wire from touching each other, wherein the electrical-heating wire includes two wires kept apart in order not to touch each other and with ends of the two wires connected to each other, and terminal connected to each of the ends is exposed to one of the two ends of the metal tube.

Also, in the invention, at each of the one end and the other end of the metal tube are installed a terminal-fixing cap and a plug.

Also, in the invention, in the metal tube is provided a dividing wall.

### Effects of Invention

According to an embodiment, since two electrical-heating wires having opposite directions are disposed in the metal tube and even though they are generated the magnetic field (electro-magnetic wave) act in opposite directions with respect to each other, they can be reduced drastically, and therefore even though they are used in an electrical heater the effect on a human body (within 2 mG) is ignorable, such that they can be used at home even with infants or babies.

Also, since the electrical-heating wires are inserted double in the metal tube, since while maintaining the thermal efficiency as before the length of the metal tube can be reduced accordingly to the reduced length of the electrical-heating wire, and since it is possible to reduce the installation space and the size of the electrical heater thanks to the reduction of manufacturing cost and small size manufacturing, we can expect manufacturing in a small size.

### BRIEF DESCRIPTION OF DRAWINGS

FIG. 1 is a front cross-sectional view of a sheath heater according to a first embodiment of the invention;

FIG. 2 is a partially enlarged view of FIG. 1;

FIG. 3 is a cross-sectional view of FIG. 1 along A-A;

FIG. 4 is a diagram for explaining an operation of the first embodiment;

FIG. 5 is a front cross-sectional view of a sheath heater according to a second embodiment of the invention;

FIG. 6 is a partially enlarged view of FIG. 5; and

FIG. 7 is a cross-sectional view of FIG. 5 along B-B.

### DETAILED DESCRIPTION OF EMBODIMENTS OF THE INVENTION

Below, the invention is described in detail referring to the Drawings.

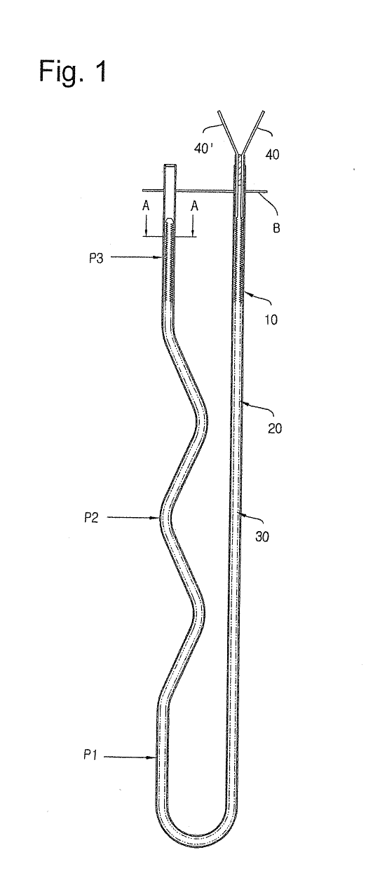

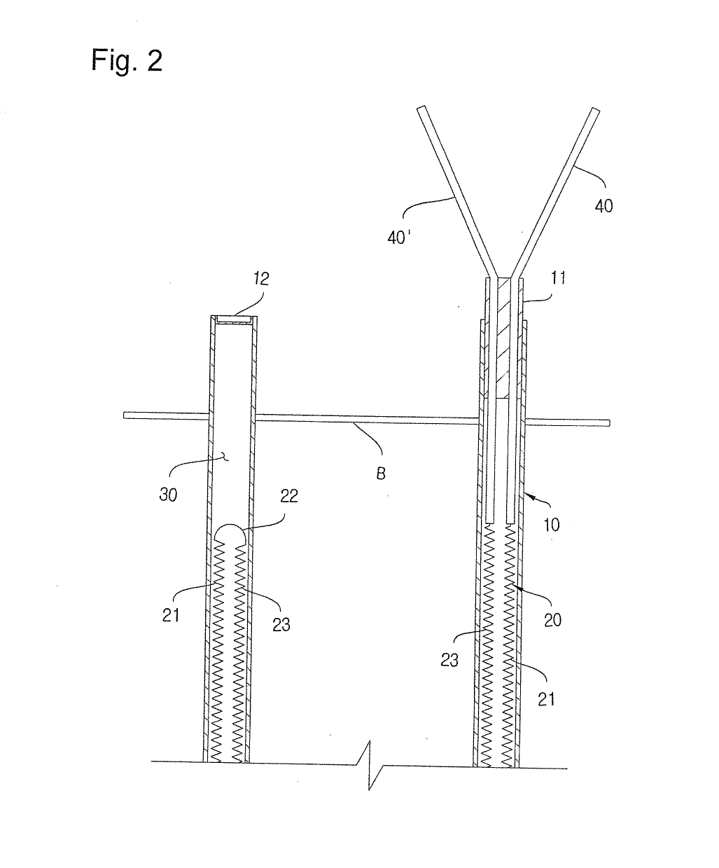

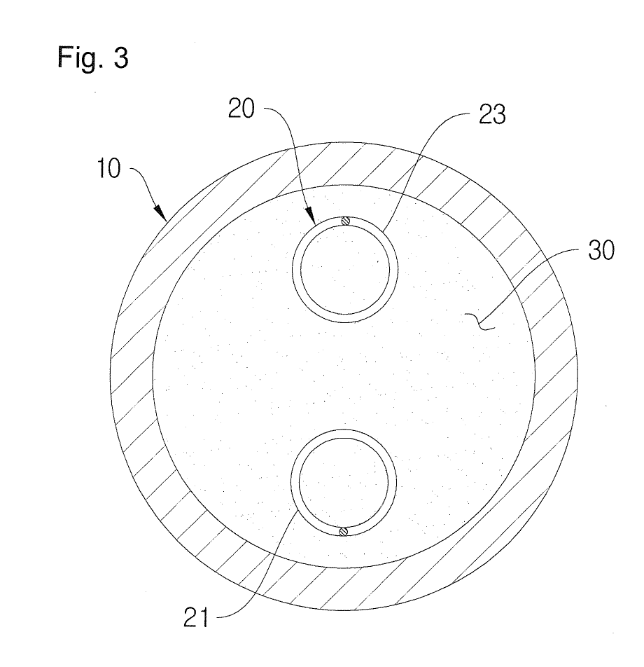

FIG. 1 is a front cross-sectional view of a sheath heater according to a first embodiment of the invention, FIG. 2 is a partially enlarged view of FIG. 1, and FIG. 3 is a cross-sectional view of FIG. 1 along A-A.

Referring to FIGS. 1-3, a sheath heater according to the first embodiment of the invention comprises a metal tube (10), a electrical-heating wire (20), a insulating powder (30), and terminals (40, 40′), and is installed in an electrical heater, receives electrical power, and generates heat.

The metal tube (10), the electrical-heating wire (20), the insulating powder (30), and the terminals (40, 40′) were elements in conventional sheath heaters.

However, the important thing is the electrical-heating wires (20) installed in the metal tube (10), and more specifically the fact that they are separated apart so as not to touch each other, have one ends connected to each other, and the terminals (40, 40′) connected to the ends are installed so as to expose to one of the two ends of the metal tube (10).

According to the above structure, since the destructive interference of the magnetic field (electro-magnetic wave) can be made by making the directions of currents opposite, the magnetic field (electro-magnetic wave) can be reduced drastically, and furthermore, since the electrical-heating wires (20) are inserted double in the metal tube (10), since while maintaining the thermal efficiency as before the length of the metal tube (10) can be reduced accordingly to the reduced length of the electrical-heating wire, and since it is possible to reduce the installation space and the size of the electrical heater thanks to the reduction of manufacturing cost and small size manufacturing, we can expect manufacturing in a small size.

Referring to FIGS. 1 and 2, the metal tube (10) is a tube with the inside penetrated through two ends.

At the both ends of the metal tube (10) are installed a terminal-fixing cap (11) and a plug (12).

Here, the terminal-fixing cap (11) blocks an end of the metal tube (10) and fixes the terminals (40, 40′), and the plug (12) blocks the other end of the metal tube (10) such that the insulating powder (30) is not leaked to outside.

And, the terminal-fixing cap (11) is preferably an insulator made of hard porcelain for insulating of the terminals (40, 40′).

Also, the metal tube (10) may be made as shown in FIGS. 1 and 2 if necessary, in which a bracket (B) of a predetermined thickness is inserted and fixed in order to keep the ends separated.

On the other hand, on an external surface of the metal tube (10) may be coated a material emitting far-infrared wave.

Here, far-infrared material may be one selected from the group consisting of tourmaline, loess, rock salt, germanium, elvan, jade, charcoal, and ceramic powder, and in this embodiment it is coated on the external surface of the metal tube (10).

Especially, since the far-infrared material has some brittleness, it is preferably coated after forming of the metal tube (10) is done.

The electrical-heating wire (20) is an electrical-heating body that generates heat when current flows therethrough, and in this embodiment it is installed in the metal tube (10).

The important thing is how the electrical-heating wires (20) are installed in the metal tube (10), and the fact that they are separated apart so as not to touch each other, have one ends connected to each other, and the terminals (40, 40′) connected to the ends are installed so as to expose to one of the two ends of the metal tube (10).

In this embodiment, the electrical-heating wire (20) is a nichrome wire having a high resistivity, a high anti-oxidation in high temperatures, and a high anti-corrosiveness, but high manufacturability, and it may include iron-chrome, tungsten, platinum, etc.

As described in the Background, if the current flows through the electrical-heating wire (20), magnetic field (electro-magnetic wave) is generated in the electrical-heating wire (20), and the human body may be affected negatively once exposed for a given time period.

However, according to the embodiment, since two electrical-heating wires (20) having opposite directions are disposed in the metal tube (10) and even though they are generated the magnetic field (electro-magnetic wave) act in opposite directions with respect to each other, they can be reduced drastically, and therefore even though they are used in an electrical heater the effect on a human body (within 2 mG) is ignorable, such that they can be used at home even with infants or babies.

Furthermore, since the electrical-heating wires (20) are inserted double in the metal tube (10), since while maintaining the thermal efficiency as before the length of the metal tube (10) can be reduced accordingly to the reduced length of the electrical-heating wire (20), and since it is possible to reduce the installation space and the size of the electrical heater thanks to the reduction of manufacturing cost and small size manufacturing, we can expect manufacturing in a small size.

The insulating powder (30) is a powder for insulating between the metal tube (10) and the electrical-heating wire (20), and between the separated electrical-heating wires (20) and increasing the thermal conductivity, and in the embodiment MgO is used, and any other material performing equivalent function can be applied.

According to the embodiment, by filling and pressing the insulating powder (30) between the metal tube (10) and the electrical-heating wire (20), it is resistant to external physical shock and increases the thermal efficiency of the electrical thermal energy.

The terminals (40, 40′) are welded and fixed to each of the ends of the electrical-heating wire (20). Here, the terminals (40, 40′) are exposed to outside through a hole of the terminal-fixing cap (11).

The operation of the above sheath heater according to the first embodiment of the invention is going to described below.

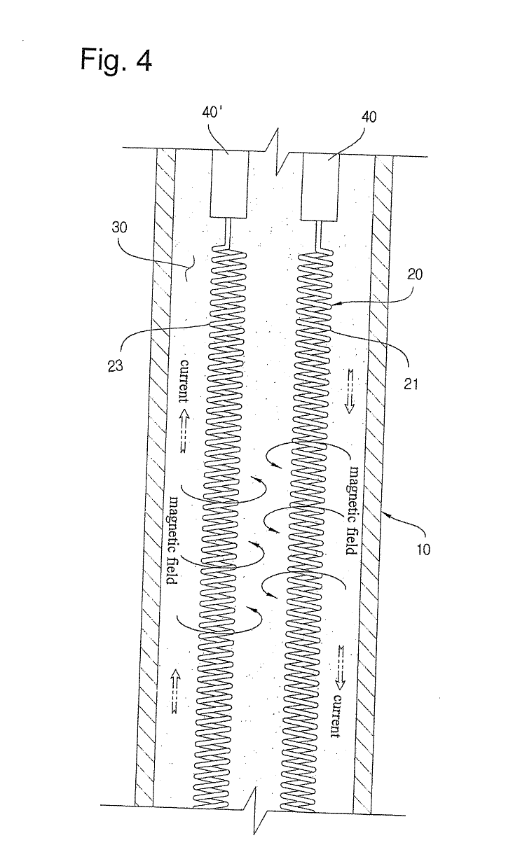

FIG. 4 is a diagram for explaining an operation of the first embodiment.

Referring to FIGS. 2 and 4, if the power is applied to the terminal (40), current flows through a first electrical-heating portion (21) of the electrical-heating wire (20), a returning portion (22), and a second electrical-heating portion (23).

And, in the process, at the first electrical-heating portion (21) and the second electrical-heating portion (23) through which current flows are generated magnetic field (electro-magnetic wave) having opposite directions.

More specifically, according to the Ampere's law, the magnetic field (electro-magnetic wave) of the first electrical-heating portion (21) is counterclockwise, and the magnetic field (electro-magnetic wave) of the second electrical-heating portion (23) is clockwise, such that the destructive interference of magnetic field (electro-magnetic wave) can be obtained, reducing the magnetic field (electro-magnetic wave) drastically.

Therefore, in a case of using the sheath heater in the above in an electrical heater, since the effect of the magnetic field (electro-magnetic wave) (less than about 2 mG) to the body is ignorable, it can be used in a house with infants and children who are growing.

Furthermore, since the electrical-heating wire (20) in the metal tube (10) is inserted by double, the thermal efficiency can be maintained as before and at the same time the length of the electrical-heating wire (20) can be shortened, reducing the length of the metal tube (10), such that the manufacturing cost can be reduced, and especially it is possible to make it small and to reduce the installation space thereof, and therefore, the electrical heater can be made small.

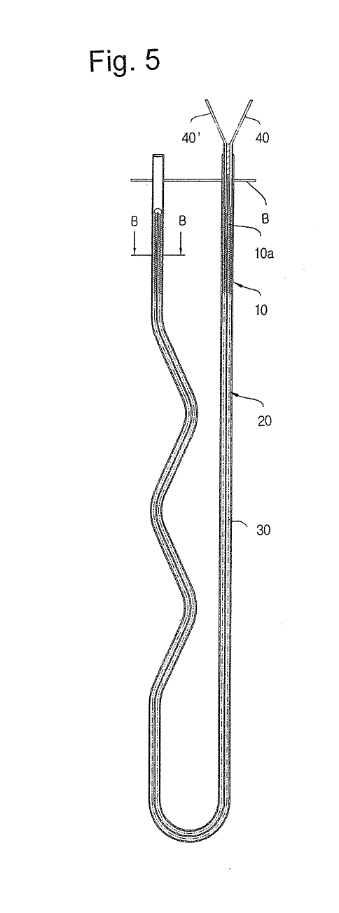

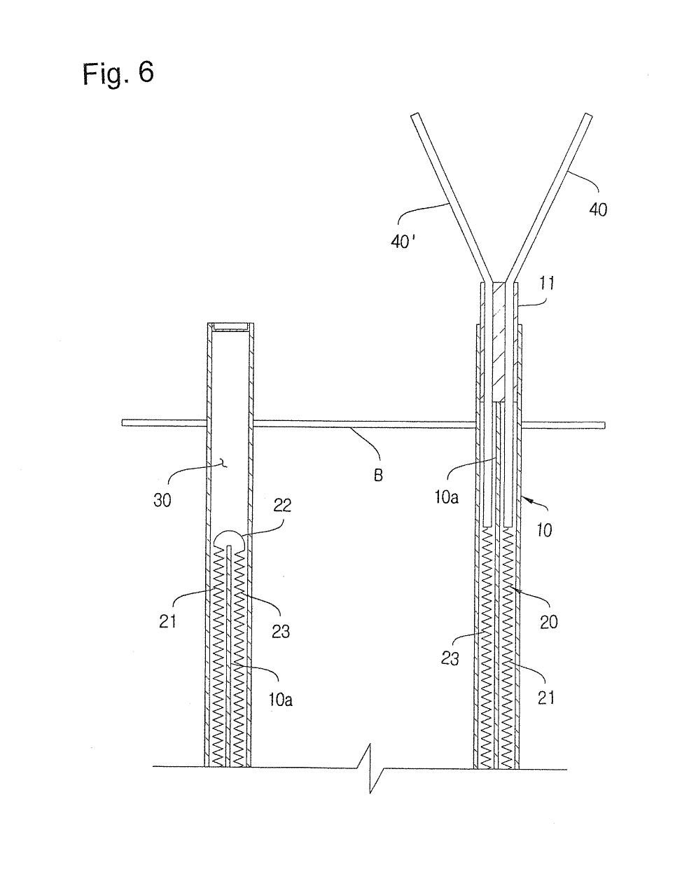

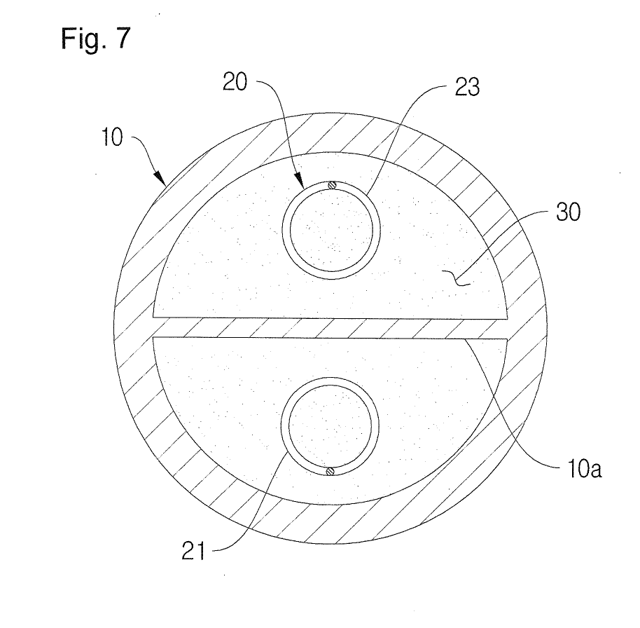

FIG. 5 is a front cross-sectional view of a sheath heater according to a second embodiment of the invention, FIG. 6 is a partially enlarged view of FIG. 5, and FIG. 7 is a cross-sectional view of FIG. 5 along B-B.

Referring to FIGS. 5 to 7, a sheath heater according to the second embodiment of the invention has the same components as the first embodiment of the invention, except that a dividing wall (10a) is provided additionally in the metal tube (10).

The dividing wall (10a) is made of the same material as the metal tube (10).

Here, the dividing wall (10a) is used to align the center of the electrical-heating wire (20) inserted in the metal tube (10).

That is, it is an assistant device for keeping the first electrical-heating portion (21) and the second electrical-heating portion (23) forming the electrical-heating wire (20) from touching each other and from being tilt aside.

There, it is preferable to keep the first electrical-heating portion (21) or the second electrical-heating portion (23) from touching the dividing wall (10a).

Since the sheath heater according to the second embodiment of the invention is equivalent to that of the first embodiment of the invention, the explanation of the operation thereof may be omitted.

The tables below are the experiments for measuring the electro-magnetic wave of the sheath heaters of the prior arts and the invention.

As shown in FIG. 1, selecting a first measuring point (P1), a second measuring point (P2), and a third measuring point (P3) of the sheath heater in the above, the electro-magnetic waves are measured at locations that are separated by a given distance (25 mm, 50 mm, 75 mm, 100 mm) from the first, second, and third measuring points (P1, P2, P3).

There, a measuring device is a model 1390 EMF Tester® of TES®, a Taiwanese company, and the unit is mG.

TABLE 1
sheath heater of the invention/sheath heater of prior arts

| | P1 | P2 | P3 |
|---|---|---|---|
| 25 mm | 3.1 mG/22.10 mG | 1.8 mG/23.70 mG | 1.9 mG/21.40 mG |
| 50 mm | 1.3 mG/15.80 mG | 0.4 mG/12.90 mG | 0.6 mG/12.60 mG |
| 75 mm | 0.5 mG/9.40 mG | 0.6 mG/8.70 mG | 0.9 mG/7.70 mG |
| 100 mm | 0.5 mG/8.90 mG | 0.9 mG/6.10 mG | 0.7 mG/5.40 mG |

In the above measurement data, the sheath heater of the invention satisfies the environment regulation (within 2 mG) from the distance of 50 mm, and shows about 81.3% reduction of electro-magnetic wave.

While the invention has been shown and described with reference to different embodiments thereof, it will be appreciated by those skilled in the art that variations in form, detail, compositions and operation may be made without departing from the spirit and scope of the invention as defined by the accompanying claims.

### REFERENCE NUMERALS

10: metal tube
10a: dividing wall
11: terminal-fixing cap
12: plug
20: electrical-heating wire
21: first electrical-heating portion
22: returning portion
23: second electrical-heating portion
30: insulating powder
40, 40′: terminals
P1: first measuring point
P2: second measuring point
P3: third measuring point

What is claimed is:

1. A sheath heater comprising:
a metal tube;
an electrical-heating wire with terminals on both ends inserted in the metal tube and exposed on both ends of the metal tube; and
a insulating powder packed therein in order to keep the metal tube and the inserted electrical-heating wire from touching each other,
wherein the electrical-heating wire includes two wires kept apart so as not to touch each other and with ends of the two wires connected to each other, and terminal connected to each of the ends is exposed to one of the two ends of the metal tube.

2. The sheath heater of claim 1, wherein a terminal-fixing cap and a plug are installed at each of the one end and the other end of the metal tube.

3. The sheath heater of claim 1, wherein a dividing wall is provided in the metal tube.

4. The sheath heater of claim 1, wherein current flows through the two wires so as to flow in opposite directions with respect to each other along the entire corresponding lengths thereof.

5. The sheath heater of claim 4, wherein each of the two wires is wound helically, wherein the two helical directions are opposite.

6. The sheath heater of claim 4, wherein the two wires have a same pitch in a direction of helical winding.

7. The sheath heater of claim 1, wherein the metal tube is bent in a U shape having two prong portions.

8. The sheath heater of claim 7, wherein one of the two prong portions of the metal tube is bent in a waveform.

9. The sheath heater of claim 3, wherein the dividing wall is made integrally with the metal tube.
